(19) United States
(12) Patent Application Publication
(10) Pub. No.: US 2019/0119093 A1
(43) Pub. Date: Apr. 25, 2019

(54) Water Containers and Dispensers with Water Cooling Systems

(71) Applicant: William J. Warren, Frisco, TX (US)

(72) Inventor: William J. Warren, Frisco, TX (US)

(21) Appl. No.: 15/950,669

(22) Filed: Apr. 11, 2018

Related U.S. Application Data
(60) Provisional application No. 62/575,123, filed on Oct. 20, 2017.

(51) Int. Cl. B67D 3/00; F25B 21/02; F25B 25/00

(52) U.S. Cl. CPC B67D 3/0009; F25B 21/02; B67D 3/0083; B67D 3/0061; F25B 25/00

(57) ABSTRACT

Water containers and dispensers with built-in water cooling systems are provided herein. An example water dispenser includes a base, a vertical sidewall extending upwards and around an outer edge of the base, a chamber being formed by the base and the vertical sidewall, a neck extending upwards from an upper portion of the vertical sidewall, a dispensing mechanism coupled to the vertical sidewall, a vapor-compression refrigeration system coupled to the base or the vertical sidewall, an electrical connector interface coupled to the vertical sidewall, a detachable bottle, and a bowl connected to the vertical sidewall and positioned beneath the dispensing mechanism. Another example water dispenser includes a thermoelectric cooling system in addition to, or in lieu of, the vapor-compression refrigeration system.

### CROSS-REFERENCE TO RELATED APPLICATION

The present application claims the benefit of U.S. Provisional Application No. 62/575,123, filed on Oct. 20, 2017, which is hereby incorporated by reference herein in its entirety for all purposes, including all references cited therein.

### FIELD

The present technology pertains to water containers and dispensers, and more specifically, but not by way of limitation, to water containers and dispensers with a built-in water cooling system such as a vapor-compression refrigeration system, a thermoelectric cooling system, and combinations thereof.

### SUMMARY

Various embodiments of the present disclosure are directed to a water container, the water container comprising: (i) a flat base; (ii) a vertical sidewall, the vertical sidewall extending upwards and around an outer edge of the flat base; (iii) a cavity, the cavity being formed by the flat base and the vertical sidewall, the cavity being for containing liquid; (iv) a vapor-compression refrigeration system coupled to at least one of the flat base and the vertical sidewall, the vapor-compression refrigeration system comprising: (a) a compressor; (b) a condenser; (c) an expansion valve; and (d) an evaporator; and (v) an electrical connector interface coupled to the vertical sidewall, the electrical connector interface being for coupling to a power source, the electrical connector interface being coupled to the vapor-compression refrigeration system.

Various embodiments of the present disclosure are directed to a water dispenser, the water dispenser comprising: (i) a dispenser portion: (a) a base; (b) a vertical sidewall, the vertical sidewall extending upwards and around an outer edge of the base; (c) a chamber, the chamber being formed by the base and the vertical sidewall, the chamber being for containing liquid; (d) a neck, the neck extending upwards from an upper portion of the vertical sidewall, the neck further comprising: (1) a lip along an upper edge of the neck; and (2) a locking mechanism on an inner sidewall of the neck; (e) a dispensing mechanism coupled to the vertical sidewall, the dispensing mechanism comprising: (1) a pipe, a first end of the pipe extending inwardly into the chamber and a second end of the pipe extending outwardly from the vertical sidewall; (2) a valve, the valve being coupled to the second end of the pipe; (3) a tap, the tap hingedly coupled to the valve for selectively opening and closing the valve; and (4) an opening, the opening being at the second end of the pipe below the valve; (f) a vapor-compression refrigeration system coupled to at least one of the base and the vertical sidewall, the vapor-compression refrigeration system comprising: (1) a compressor; (2) a condenser; (3) an expansion valve; and (4) an evaporator; and (g) an electrical connector interface coupled to the vertical sidewall, the electrical connector interface being for coupling to a power source, the electrical connector interface being coupled to the vapor-compression refrigeration system.

Various embodiments of the present disclosure are directed to a gravity water dispenser, the gravity water dispenser comprising: (i) a dispenser portion, the dispenser portion comprising: (a) a base; (b) a vertical sidewall, the vertical sidewall extending upwards and around an outer edge of the base; (c) a chamber, the chamber being formed by the base and the vertical sidewall, the chamber being for containing liquid; (d) a neck, the neck extending upwards from an upper portion of the vertical sidewall, the neck further comprising: (1) a lip along an upper edge of the neck; and (2) a locking mechanism on an inner sidewall of the neck; (e) an opening in the vertical sidewall, the opening having a first end that opens into the chamber and a second end that opens into an outer portion of the vertical sidewall; (f) a vapor-compression refrigeration system coupled to at least one of the base and the vertical sidewall, the vapor-compression refrigeration system comprising: (1) a compressor; (2) a condenser; (3) an expansion valve; and (4) an evaporator; and (g) an electrical connector interface coupled to the vertical sidewall, the electrical connector interface being for coupling to a power source, the electrical connector interface being coupled to the vapor-compression refrigeration system.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1A is a perspective view of a water container with a built-in water cooling system, according to an exemplary embodiment.

FIG. 1B is a sectional view of the water container of FIG. 1A, according to an exemplary embodiment.

FIG. 2 is a block diagram illustrating a vapor-compression refrigeration system, according to an exemplary embodiment.

FIG. 3 is a perspective view of a water dispenser with a built-in water cooling system, according to an exemplary embodiment.

FIG. 4 is a perspective view of a gravity water dispenser with a built-in water cooling system, according to an exemplary embodiment.

FIG. 5 is a schematic diagram illustrating a thermoelectric cooling system, according to an exemplary embodiment.

### DETAILED DESCRIPTION

The present disclosure is now described more fully with reference to the accompanying drawings, in which example embodiments of the present disclosure are shown. The present disclosure may, however, be embodied in many different forms and should not be construed as necessarily being limited to the example embodiments set forth herein. Rather, these example embodiments are provided so that the disclosure is thorough and complete, and fully conveys the concepts of the present disclosure to those skilled in the art. Also, features described with respect to certain example embodiments may be combined in and/or with various other example embodiments. Different aspects and/or elements of example embodiments, as disclosed herein, may be combined in a similar manner. Further, at least some example embodiments may individually and/or collectively be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity, at least as described herein, in any manner, irrespective of the at least one entity have any relationship to the subject matter of the present disclosure.

Generally described, the present technology involves water containers and dispensers with a built-in water cooling system. Example types of water cooling systems that can be used to cool the water (or any liquid) using the present technology include, but are not limited to, vapor-compression refrigeration system , a thermoelectric cooling system, and other similar cooling systems.

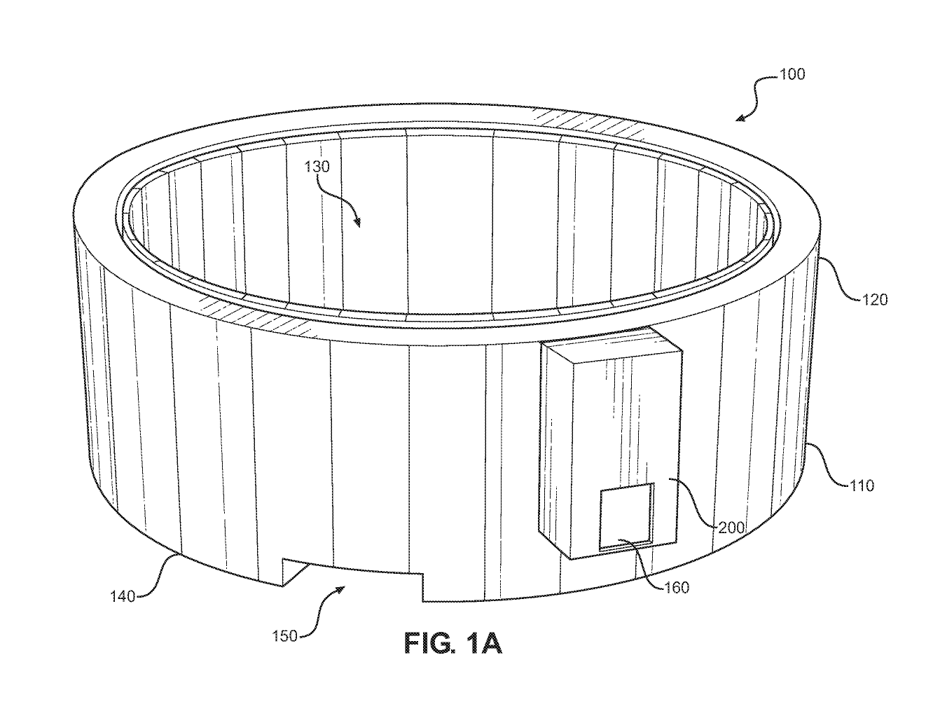

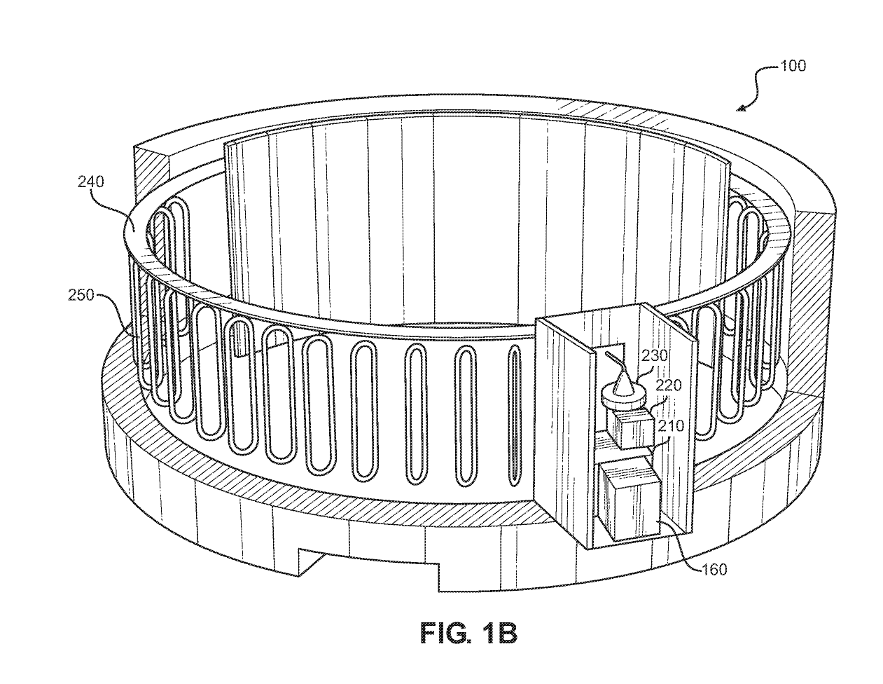

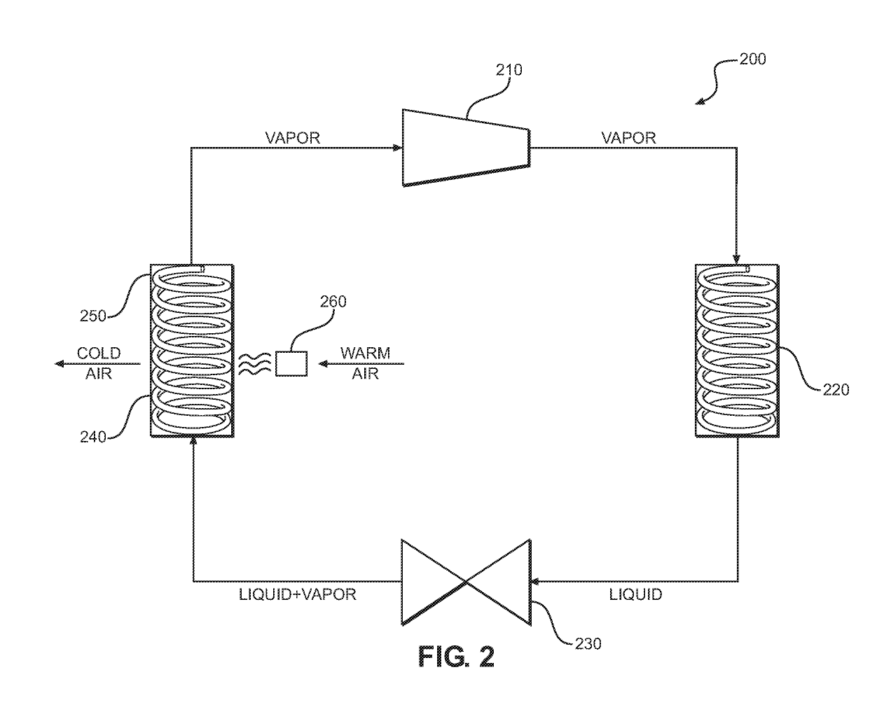

FIGS. 1A and 1B illustrate an exemplary water container with a built-in water cooling system. In various embodiments, water container 100 generally comprises a (substantially flat) base 110, a (substantially) vertical sidewall 120 extending upwards and around outer edge of base 110 to form a cavity 130, legs 140, gap(s) 150, an electrical connector interface 160, and a vapor-compression refrigeration system 200 (described in further detail in FIG. 2).

According to various embodiments, base 110 and sidewall 120 of water container 100 (particularly portions of water container 100 that contact the liquid to be consumed by a person or an animal) can be constructed from materials such as stainless steel, aluminum, silicone, BPA-free plastic, polymer, ceramic, stoneware, glass, combinations thereof, and any other commonly used materials for water containers and dispensers that are safe for consumption. Cavity 130 can hold liquid or edible products for consumption.

Some embodiments of water container 100 can have legs 140 for elevating water container 100, such that base 110 of water container 100 does not touch the ground or floor on which water container 100 is placed. In other words, there is a space between base 110 and the ground. In further embodiments, water container 100 can have one or more gaps 150 between legs 140. The one or more gaps 150 can allow for heat dissipation.

In the illustrated embodiment of water container 100, water container 100 can include a vapor-compression refrigeration system 200 for cooling liquid in water container 100 (vapor-compression refrigeration system 200 is further described in detail in FIG. 2). Vapor-compression refrigeration system 200 can be built into sidewall 120 and/or base 110 of water container 110, according to various embodiments.

In an exemplary embodiment, vapor-compression refrigeration system 200 of water container 100 can include a compressor 210, a condenser 220, an expansion valve 230, and an evaporator 240 that can have coil or tubes 250. It should be noted that coil or tubes 250 of evaporator 240 of vapor-compression refrigeration system 200 can absorb heat from cavity 130 (which is capable of holding liquid) and cools any liquid that is in cavity 130. In one embodiment, compressor 210, condenser 220, and expansion valve 230 can be enclosed in a housing within sidewall 120. In a further embodiment, evaporator 240 can be in sidewall 120 and surround cavity 130.

Further embodiments include an electrical connector interface 160. Electrical connector interface 160 can be for electrically coupling a power source to or for providing power/electricity to vapor-compression refrigeration system 200. Electrical connector interface 160 can comprise, for example, electrical prongs (which would allow water container 100 to be plugged directly into an electrical outlet), an electrical cable (the electrical cable can be any of a charging cable, a FireWire cable, a USB cable, a micro-USB cable, a lightning cable, a retractable cable, a waterproof cable, a cable that is coated/covered with a material that would prevent an animal from chewing through to the electrical wiring, and combinations thereof), electrical ports (such as a USB port, micro-USB port, microSD port, etc.), a connector for batteries (including rechargeable battery, non-rechargeable battery, battery packs, external chargers, portable power banks, etc.), and any other standard power source used to provide electricity/power to household appliances and devices.

FIG. 2 is a block diagram illustrating a vapor-compression refrigeration system, according to an exemplary embodiment. In the illustrated embodiment, vapor-compression refrigeration system 200 (also referred to herein as system 200) can include a compressor 210, a condenser 220, an expansion valve 230, and an evaporator 240. In some embodiments, system 200 can include additional or other components necessary for operation of system 200. Similarly, in other embodiments, system 200 can include fewer components that perform functions similar or equivalent to those depicted in the illustrated embodiment of FIG. 2.

According to various embodiments, the vapor-compression refrigeration system 200 can include the use of a circulating (liquid) refrigerant as a medium that first absorbs and removes heat from the space or liquid to be cooled, and then rejects the heat elsewhere. Examples of refrigerants include, but are not limited, to ammonia, carbon dioxide, sulfur dioxide, non-halogenated hydrocarbons (e.g., propane), hydrofluorocarbons, fluorocarbons, and the like.

Various examples of compressor 210 can include any gas compressor such as a rotary screw compressor (e.g., a positive-displacement compressor using two meshing helical screws or rotors rotating in opposite directions to compress gas and reduce the volume of the gas along the rotors to the discharge point), a reciprocating compressor (e.g., a positive-displacement compressor that uses pistons driven by a crankshaft to deliver gases at a high pressure), a centrifugal compressor (e.g., a dynamic compressor that raises the pressure of a fluid by imparting velocity or dynamic energy using a rotating impeller and converting it to pressure energy), a scroll compressor (e.g., a positive-displacement compressor that compresses a fluid when one spiral orbits around a second stationary spiral that creates smaller and smaller pockets and higher pressures), and the like.

At compressor 210, refrigerant enters compressor 210 as a vapor and is compressed to higher pressure, which results also in a higher temperature. The vapor refrigerant, now a hot, compressed vapor (i.e., superheated vapor), is then routed to condenser 220.

In various examples, condenser 220 can be any device used to condense a substance from its gaseous/vapor form to its liquid form by cooling the substance. The condenser 220 may have a heat exchanger section to cool down the substance, according to various examples.

At condenser 220, the vapor refrigerant from compressor 210 is condensed by, for example, cooling water or cooling air flowing across coils or tubes of condenser 220. In other words, heat is rejected from system 200 to surrounding environment 250 and carried away by water and/or air. After being routed through condenser 220, the vapor refrigerant has been converted to liquid form.

Various examples of expansion valve 230 can include any of a thermal expansion valve, a throttle valve, a metering device, and the like.

At expansion valve 230, the liquid refrigerant from condenser 220 undergoes an abrupt reduction in pressure, which results in a flash evaporation of some of the liquid refrigerant. The flash evaporation lowers the temperature of the remaining liquid refrigerant, such that the mixture of liquid and vapor refrigerant is cooler than the temperature of the space to be cooled.

In various examples, evaporator 240 can be any device used to turn a liquid form of a substance into its gaseous/vapor form. The liquid is evaporated, or vaporized, into a gaseous/vapor form of the substance. One example of evaporator 240 is a radiator coil used in a closed compressor driven circulation of a liquid coolant that allows a compressed cooling chemical (for example, R-22 (e.g., Freon), R-410A, and the like) to evaporate/vaporize from liquid to gas within the system while absorbing heat from the space or enclosed area to be cooled, for example.

At evaporator 240, the cold mixture of liquid and vapor refrigerant from expansion valve 230 is routed through coil or tubes 250 in evaporator 240. As the cold mixture of liquid and vapor refrigerant circulates through the coil or tubes 250 in evaporator 240, the temperature of the space to be cooled is lowered. In various examples of system 200, a fan 260 can be used to circulate warm air from the space to be cooled across the coil or tubes 250 carrying the cold mixture of liquid and vapor refrigerant. In other words, the refrigerant absorbs heat from the space to be cooled (e.g., cavity 130) at evaporator 240, thereby lowering the temperature of the space to be cooled.

Further embodiments of vapor-compression refrigeration system 200 can also include or be used in conjunction with any of a (digital or analog) thermometer for measuring temperature of liquid, a (manual or automatic) switch for turning on and off system 200, a thermostat for (manually or automatically) controlling the turning on and off of system 200, and combinations thereof.

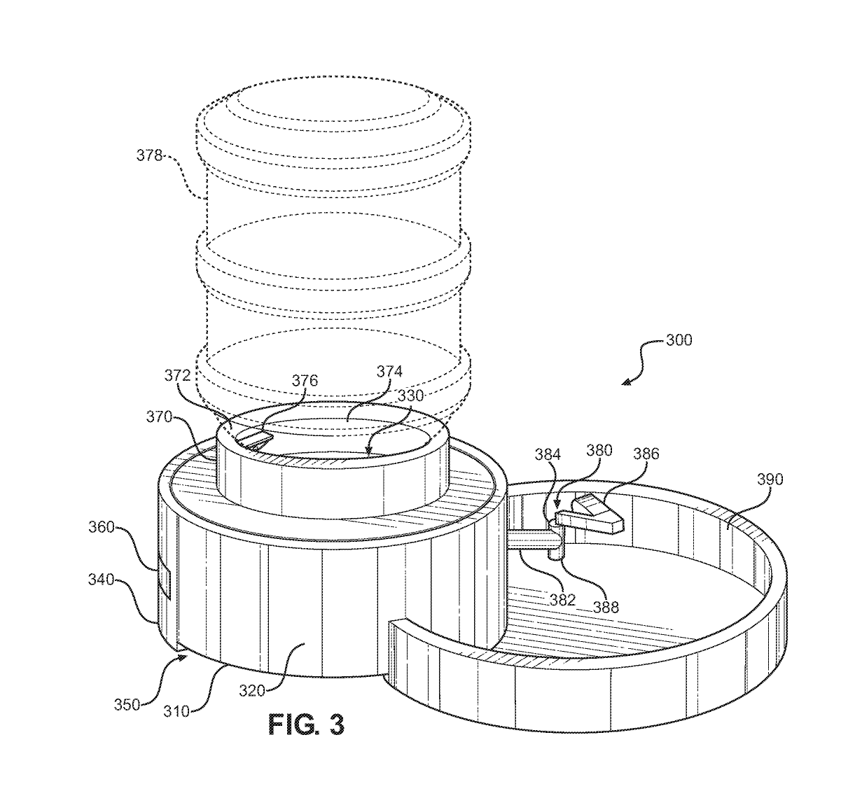

FIG. 3 illustrates an exemplary water dispenser with a built-in water cooling system. In various embodiments, water dispenser 300 generally comprises a dispenser portion and a bowl portion. The dispenser portion can include a (substantially flat) base 310, a (substantially vertical) sidewall 320 extending upwards and around outer edge of base 310 to form a chamber 330, leg(s) 340, gap(s) 350, an electrical connector interface 360, a neck 370, a dispensing mechanism 380, and a vapor-compression refrigeration system 200 (as described in FIG. 2). The bowl portion can include a bowl 390 (or any container that is shaped like a bowl or dish that is capable of holding liquid).

It should be noted that, similar to the various embodiments of water container 100 described in FIGS. 1A and 1B, various embodiments of vapor-compression system 200 of water dispenser 300 can be similar to that of water container 100. For example, vapor-compression refrigeration system 200 of water dispenser 300 can also include a compressor 210, a condenser 220, an expansion valve 230, and an evaporator 240 that can have coil or tubes 250, which are built into sidewall 320 similar to the illustrated embodiment of vapor-compression refrigeration system 200 of water container 100 as illustrated in FIG. 1B. It should be noted that coil or tubes 250 of evaporator 240 of vapor-compression refrigeration system 200 of water dispenser 300 absorbs heat from chamber 330 (which is capable of holding liquid) and cools any liquid that is in chamber 330.

According to various embodiments, base 310, sidewall 320, neck 370, dispensing mechanism 380, and bowl 390 (as well as other components of water dispenser 300, particularly portions of water dispenser 300 that contact the liquid to be consumed by a person or an animal) can be constructed from materials such as stainless steel, aluminum, silicone, BPA-free plastic, polymer, ceramic, stoneware, glass, combinations thereof, and any other commonly used materials for water containers and dispensers that are safe for consumption.

Some embodiments of water dispenser 300 can have leg(s) 340 for elevating water dispenser 300, such that base 310 of water dispenser 300 does not touch the ground or floor on which water dispenser 300 is placed. In other words, there is a space between base 310 and the ground. In further embodiments, water dispenser 300 can have one or more gaps 350 between leg(s) 340 and/or bowl 390. The one or more gaps 350 can allow for heat dissipation.

Further embodiments include an electrical connector interface 360. Electrical connector interface 360 can be similar to electrical connector interface 160 as described in relation to FIGS. 1A and 1B.

In various embodiments, sidewall 320 can have a neck 370 with a lip 372 along an upper edge of neck 370. Neck 370 can extend upwards from an upper portion of sidewall 320. Inner sidewall 374 of neck 370 can have a locking (or fitting) mechanism 376. Neck 370 can have contaminant filters or antimicrobial filters, in some embodiments. Locking mechanism 376 can be used to hold a (removable) bottle 378 in an inverted position and to prevent bottle 378 from inadvertent detachment from water dispenser 300, for example. When bottle 378 is inverted, liquid from bottle 378 fills chamber 330 with liquid. Bottle 378 can sit on top of lip 372 when bottle 378 is locked or secured into place by locking mechanism 376. Examples of locking mechanism 376 can include a tab/notch mechanism (as illustrated) for holding bottle 378 in an inverted position, screw-type threads (with corresponding screw-type threads on bottle 378), and the like. Bottle 378 can be plastic, glass, and any other materials that are safe for human or animal consumption.

In further embodiments, dispensing mechanism 380 (which can be similar to a faucet or a tap, in some examples) can extend from sidewall 320. Dispensing mechanism 380 can include a pipe 382, a valve 384, a tap 386, and an opening 388. Pipe 382 extends horizontally from sidewall 330, with one end (not shown) extending into chamber 330, such that liquid from chamber 330 can flow into pipe 382. Pipe 382 can be positioned on top of base 310 or slightly above base 310 to help facilitate flow of liquid from chamber 330. The opposing end of pipe 382 is coupled to valve 384. Valve 384 controls the flow (or release) of liquid from chamber 330. Tap 386 can be hingedly coupled to valve 384. Tap 386 can open and close valve 384. For example, when tap 388 is depressed or lifted by a person or an animal/pet (using its paws, nose, or other body part), tap 386 can open valve 384, which allows for liquid in chamber 330 to flow through pipe 382 and out of opening 388 into bowl 390. Liquid in chamber 330 can be selectively cooled/chilled prior to dispensing into bowl 390.

In some embodiments, bowl 390 is positioned below dispensing mechanism 380. In other embodiments, bowl 390 can be removably coupled to sidewall 320 and/or base 310, such that another bowl could be placed beneath dispensing mechanism 380 or to facilitate cleaning of bowl 390, for example.

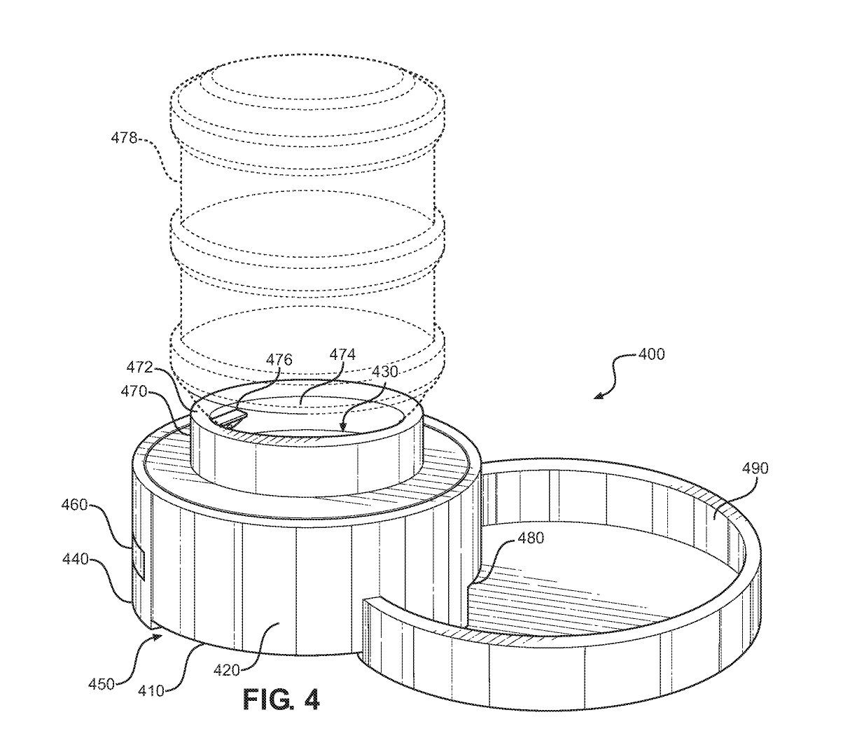

FIG. 4 illustrates an exemplary gravity water dispenser with a built-in water cooling system. In various embodiments, gravity water dispenser 400 generally comprises a dispenser portion and a bowl portion. The dispenser portion can include a (substantially flat) base 410, a (substantially vertical) sidewall 420 extending upwards and around outer edge of base 410 to form a chamber 430, leg(s) 440, gap(s) 450, an electrical connector interface 460, a neck 470, an opening 480, and a vapor-compression refrigeration system 200 (as described in FIG. 2). The bowl portion can include a bowl 490 (or any container that is shaped like a bowl or dish that is capable of holding liquid).

It should be noted that, similar to the various embodiments of water container 100 described in FIGS. 1A and 1B, various embodiments of vapor-compression system 200 of gravity water dispenser 400 can be similar to that of water container 100. For example, vapor-compression refrigeration system 200 of gravity water dispenser 400 can also include a compressor 210, a condenser 220, an expansion valve 230, and an evaporator 240 that can have coil or tubes 250, which are built into sidewall 420 similar to the illustrated embodiment of vapor-compression refrigeration system 200 of water container 100 as illustrated in FIG. 1B. It should be noted that coil or tubes 250 of evaporator 240 of vapor-compression refrigeration system 200 of gravity water dispenser 400 absorbs heat from chamber 430 (which is capable of holding liquid) and cools any liquid that is in chamber 430.

According to various embodiments, base 410, sidewall 420, neck 470, opening 480, and bowl 490 (as well as other components of gravity water dispenser 400, particularly portions of gravity water dispenser 400 that contact the liquid to be consumed by a person or an animal) can be constructed from materials such as stainless steel, aluminum, silicone, BPA-free plastic, polymer, ceramic, stoneware, glass, combinations thereof, and any other commonly used materials for water containers that are safe for consumption.

Some embodiments of gravity water dispenser 400 can have leg(s) 440 for elevating gravity water dispenser 400, such that base 410 of gravity water dispenser 400 does not touch the ground or floor on which gravity water dispenser 400 is placed. In other words, there is a space between base 410 and the ground. In further embodiments, gravity water dispenser 400 can have one or more gaps 450 between leg(s) 440 and/or bowl 490. The one or more gaps 450 can allow for heat dissipation.

Further embodiments include an electrical connector interface 460. Electrical connector interface 460 can be similar to electrical connector interface 160 as described in relation to FIGS. 1A and 1B.

In various embodiments, sidewall 420 can have a neck 470 with a lip 472 along an upper edge of neck 470. Neck 470 can extend upwards from an upper portion of sidewall 420. Neck 470 can have contaminant filters or antimicrobial filters, in some embodiments. In other embodiments, neck 470 can have a water flow regulator that couples to opening/mouth of bottle 478 to help control the flow of liquid from bottle 478 into chamber 430. Inner sidewall 474 of neck 470 can have a locking (or fitting) mechanism 476. Locking mechanism 476 can be used to hold a (removable) bottle 478 in an inverted position and to prevent bottle 478 from inadvertent detachment from gravity water dispenser 400, for example). When bottle 478 is inverted, liquid from bottle 478 fills chamber 430 with liquid. Bottle 478 can sit on top of lip 472 when bottle 478 is locked or secured into place by locking mechanism 476. Examples of locking mechanism 476 can include a tab/notch mechanism (as illustrated) for holding bottle 478 in an inverted position, screw-type threads (with corresponding screw-type threads on bottle 478), and the like. Bottle 478 can be plastic, glass, and any other materials that are safe for consumption.

In further embodiments, liquid flows out of inverted bottle 478 into chamber 430 and then flows out of opening 480 into bowl 490 via gravity. As liquid is consumed (or evaporates), liquid automatically flows out of opening 480 to refill bowl 490 without overfilling bowl 490. Liquid in chamber 430 can be selectively cooled/chilled.

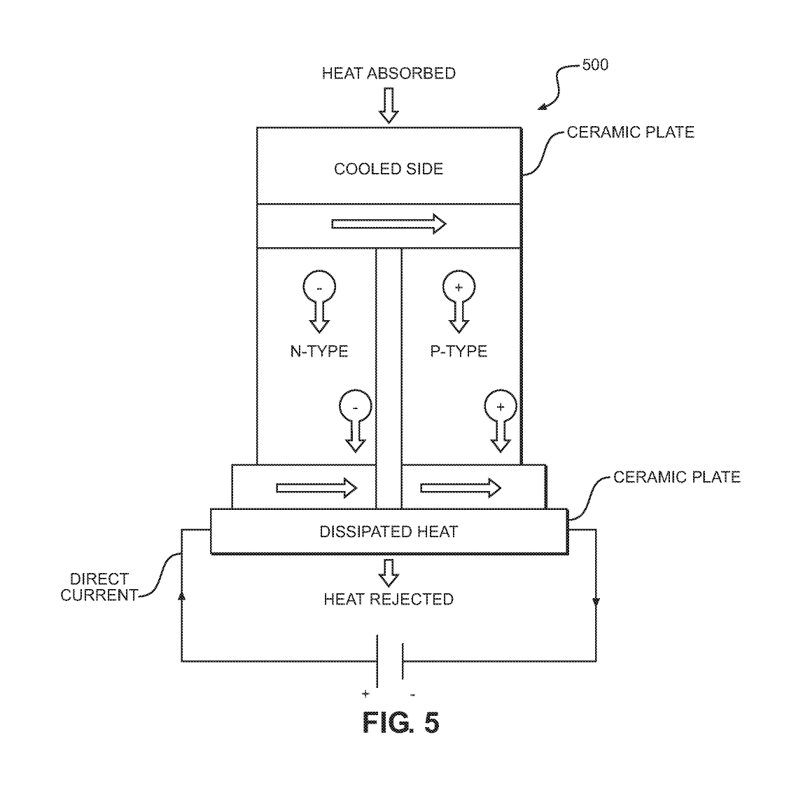

According to further embodiments, any of the exemplary embodiments described above in regards to water container 100 of FIGS. 1A and 1B, water dispenser 300 of FIG. 3, and gravity water dispenser 400 of FIG. 4 can have a built-in thermoelectric cooling system 500 (described in further detail in FIG. 5) in addition to, or in lieu of, vapor-compression refrigeration system 200 as described in FIG. 2.

FIG. 5 is a schematic diagram illustrating a thermoelectric cooling system, according to an exemplary embodiment. The thermoelectric cooling system 500 (also referred to herein as system 500) can operate by thermoelectric effect (e.g., Peltier effect). In the illustrated embodiment, thermoelectric cooling system 500 can include two bonded semiconductors (“n-type” and “p-type” semiconductors) between two ceramic plates (or substrates). In some embodiments, system 500 can include additional or other components necessary for operation of system 500. Similarly, in other embodiments, system 500 can include fewer components that perform functions similar or equivalent to those depicted in the illustrated embodiment of FIG. 5.

In various embodiments, the n-type semiconductors and p-type semiconductors are placed thermally in parallel to each other and electrically in series. The n-type semiconductors and p-type semiconductors are coupled between two thermally conducting plates (e.g., ceramic plates) on each side. The n-type semiconductors and p-type semiconductors can be comprised of an alloy of bismuth telluride, for example. In general, n-type semiconductors have an overabundance of electrons and p-type semiconductors lack a full set of electrons.

When an electrical current is passed through the semiconductors, the electrons move from the n-type semiconductor to the p-type semiconductor, carrying heat with them and leaving a cool surface. In other words, when an electrical current from a power source is applied to the free ends of the two semiconductors, the flow of direct current across the junction of the n-type and p-type semiconductors causes a temperature difference between the two conducting plates.

In various embodiments, water container 100 of FIGS. 1A and 1B can have a built-in thermoelectric cooling system 500 in addition to, or in lieu of, vapor-compression refrigeration system 200 as described in FIG. 2. In one embodiment, thermoelectric cooling system 500 can be built into base 110 of water container 100 and electrically coupled to electrical connector interface 160 and/or to vapor-compression refrigeration system 200. More specifically, heat can be absorbed from liquid in cavity 130, thereby cooling the liquid. The absorbed heat can be rejected to the space between base 110 and the ground. The heat can then dissipate out of the one or more gaps 150 and into surrounding environment.

According to various embodiments, water dispenser 300 of FIG. 3 can have a built-in thermoelectric cooling system 500 in addition to, or in lieu of, vapor-compression refrigeration system 200 as described in FIG. 2. In some embodiments, thermoelectric cooling system 500 can be built into base 310 of water dispenser 300 and electrically coupled to electrical connector interface 360 and/or to vapor-compression refrigeration system 200. More specifically, heat can be absorbed from liquid in chamber 330, thereby cooling the liquid. The absorbed heat can be rejected to the space between base 310 and the ground. The heat can then dissipate out of the one or more gaps 350 and into surrounding environment. In other embodiments, thermoelectric cooling system 500 can be built into bowl 390 or bottom of bowl 390 in addition to, or in lieu of, being built into base 310.

In various embodiments, gravity water dispenser 400 of FIG. 4 can have a built-in thermoelectric cooling system 500 in addition to, or in lieu of, vapor-compression refrigeration system 200 as described in FIG. 2. In some embodiments, thermoelectric cooling system 500 can be built into base 410 of gravity water dispenser 400 and electrically coupled to electrical connector interface 460 and/or to vapor-compression refrigeration system 200. More specifically, heat can be absorbed from liquid in chamber 430, thereby cooling the liquid. The absorbed heat can be rejected to the space between base 410 and the ground. The heat can then dissipate out of the one or more gaps 450 and into surrounding environment. In other embodiments, thermoelectric cooling system 500 can be built into bowl 490 or bottom of bowl 490 in addition to, or in lieu of, being built into base 410.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing and/or other any other types of manufacturing. For example, some manufacturing processes include three dimensional (3D) printing, laser cutting, computer numerical control (CNC) routing, milling, pressing, stamping, vacuum forming, hydroforming, injection molding, lithography and/or others.

Any and/or all elements, as disclosed herein, can include, whether partially and/ or fully, a solid, including a metal, a mineral, a ceramic, an amorphous solid, such as glass, a glass ceramic, an organic solid, such as wood and/or a polymer, such as rubber, a composite material, a semiconductor, a nano-material, a biomaterial and/or any combinations thereof. Any and/or all elements, as disclosed herein, can include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, non-transparency, luminescence, anti-reflection and/or holographic, a photo-sensitive coating, an electronic and/or thermal property coating, such as for passivity, insulation, resistance or conduction, a magnetic coating, a water-resistant and/or waterproof coating, a scent coating and/or any combinations thereof.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A water container, the water container comprising:
a flat base;
a vertical sidewall, the vertical sidewall extending upwards and around an outer edge of the flat base;
a cavity, the cavity being formed by the flat base and the vertical sidewall, the cavity being for containing liquid;
a vapor-compression refrigeration system coupled to at least one of the flat base and the vertical sidewall, the vapor-compression refrigeration system comprising:
a compressor;
a condenser;
an expansion valve; and
an evaporator; and
an electrical connector interface coupled to the vertical sidewall, the electrical connector interface being for coupling to a power source, the electrical connector interface being coupled to the vapor-compression refrigeration system.

2. The water container of claim 1, wherein the vertical sidewall further comprises a housing, the housing enclosing the compressor, the condenser, and the expansion valve, and further wherein the evaporator comprises a portion of the vertical sidewall that surrounds the cavity.

3. The water container of claim 1, wherein the flat base further comprises:
two or more legs extending downward from the flat base; and
one or more gaps between the two or more legs.

4. The water container of claim 1, wherein the flat base further comprises a thermoelectric cooling system, the thermoelectric cooling system being electrically coupled to at least one of the electrical connector interface and the vapor-compression refrigeration system.

5. The water container of claim 1, wherein the electrical connector interface comprises at least one of electrical prongs, an electrical cable, an electrical port, and a connector for batteries.

6. A water dispenser, the water dispenser comprising:
a dispenser portion, the dispenser portion comprising:
a base;
a vertical sidewall, the vertical sidewall extending upwards and around an outer edge of the base;
a chamber, the chamber being formed by the base and the vertical sidewall, the chamber being for containing liquid;
a neck, the neck extending upwards from an upper portion of the vertical sidewall, the neck further comprising:
a lip along an upper edge of the neck; and
a locking mechanism on an inner sidewall of the neck;
a dispensing mechanism coupled to the vertical sidewall, the dispensing mechanism comprising:
a pipe, a first end of the pipe extending inwardly into the chamber and a second end of the pipe extending outwardly from the vertical sidewall;
a valve, the valve being coupled to the second end of the pipe;
a tap, the tap hingedly coupled to the valve for selectively opening and closing the valve; and
an opening, the opening being at the second end of the pipe below the valve;
a vapor-compression refrigeration system coupled to at least one of the base and the vertical sidewall, the vapor-compression refrigeration system comprising:
a compressor;
a condenser;
an expansion valve; and
an evaporator; and
an electrical connector interface coupled to the vertical sidewall, the electrical connector interface being for coupling to a power source, the electrical connector interface being coupled to the vapor-compression refrigeration system.

7. The water dispenser of claim 6, further comprising a bottle, the bottle being detachable from the dispenser portion.

8. The water dispenser of claim 7, wherein the locking mechanism on the inner sidewall of the neck secures the bottle in an inverted position such that liquid from the bottle can flow into the chamber, the locking mechanism being any of a tab and notch locking mechanism and a screw-type locking mechanism.

9. The water dispenser of claim 6, further comprising a bowl portion, the bowl portion comprising a bowl connected to the vertical sidewall, the bowl being positioned beneath the dispensing mechanism.

10. The water dispenser of claim 9, wherein the base further comprises:
one or more legs extending downward from the base; and
one or more gaps between the one or more legs and the bowl.

11. The water dispenser of claim 10, wherein at least one of the base and the bowl further comprises a thermoelectric cooling system, the thermoelectric cooling system being electrically coupled to at least one of the electrical connector interface and the vapor-compression refrigeration system.

12. The water dispenser of claim 6, wherein the vertical sidewall further comprises a housing, the housing enclosing the compressor, the condenser, and the expansion valve, and further wherein the evaporator comprises a portion of the vertical sidewall that surrounds the chamber.

13. A gravity water dispenser, the gravity water dispenser comprising:
a dispenser portion, the dispenser portion comprising:
a base;
a vertical sidewall, the vertical sidewall extending upwards and around an outer edge of the base;
a chamber, the chamber being formed by the base and the vertical sidewall, the chamber being for containing liquid;
a neck, the neck extending upwards from an upper portion of the vertical sidewall, the neck further comprising:
a lip along an upper edge of the neck; and
a locking mechanism on an inner sidewall of the neck;
an opening in the vertical sidewall, the opening having a first end that opens into the chamber and a second end that opens into an outer portion of the vertical sidewall;
a vapor-compression refrigeration system coupled to at least one of the base and the vertical sidewall, the vapor-compression refrigeration system comprising:
a compressor;
a condenser;
an expansion valve; and
an evaporator; and
an electrical connector interface coupled to the vertical sidewall, the electrical connector interface being for coupling to a power source, the electrical connector interface being coupled to the vapor-compression refrigeration system.

14. The gravity water dispenser of claim 13, further comprising a bottle, the bottle being detachable from the dispenser portion.

15. The gravity water dispenser of claim 14, wherein the locking mechanism on the inner sidewall of the neck secures the bottle in an inverted position such that liquid from the bottle can flow into the chamber, the locking mechanism being any of a tab and notch locking mechanism and a screw-type locking mechanism.

16. The gravity water dispenser of claim 14, wherein the neck further comprises any of a water flow regulator, a contaminant filter, an antimicrobial filter, and combinations thereof.

17. The gravity water dispenser of claim 13, further comprising a bowl portion, the bowl portion comprising a bowl connected to the vertical sidewall, the bowl being positioned such that the second end of the opening opens into the bowl.

18. The gravity water dispenser of claim 17, wherein the base further comprises:
one or more legs extending downward from the base; and
one or more gaps between the one or more legs and the bowl.

19. The gravity water dispenser of claim 18, wherein at least one of the base and the bowl further comprises a thermoelectric cooling system, the thermoelectric cooling system being electrically coupled to at least one of the electrical connector interface and the vapor-compression refrigeration system.

20. The gravity water dispenser of claim 13, wherein the vertical sidewall further comprises a housing, the housing enclosing the compressor, the condenser, and the expansion valve, and further wherein the evaporator comprises a portion of the vertical sidewall that surrounds the chamber.
